(19) United States
(12) Patent Application Publication
(10) Pub. No.: US 2003/0159143 A1
(43) Pub. Date: Aug. 21, 2003

(54) Systems and methods for generating a real-time video program guide through video access of multiple channels

(76) Inventor: Peter Chan, Lawrenceville, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/080,380

(22) Filed: Feb. 21, 2002

(51) Int. Cl. H04N 5/445; H04N 7/16

(52) U.S. Cl. 725/41; 725/144; 725/39

(57) ABSTRACT

Systems, methods and apparatuses enabling a subscriber to access video corresponding to multiple channels within a very short period of time. A dedicated transmission channel transmits a data stream generated by a content provider, where the data stream includes data representing a plurality of video pictures associated with a plurality of television channels. Populating one data stream with data corresponding to multiple channels enables a Home Communication Terminal (HCT), in communication with a display device, to display multiple channels in a Composite Presentation to the subscriber. The Composite Presentation allows a subscriber to view a plurality of television channels on one channel, obviating the time consuming requirement that a subscriber re-tune to a separate television channel each time the subscriber wishes to view a video picture associated with a different television channel.

### FIELD OF THE INVENTION

The present invention relates generally to real-time video program guides, and more particularly, to systems, apparatuses and methods for generating a composite video program guide presentation that displays a plurality of video pictures.

### BACKGROUND OF THE INVENTION

Over the past twenty years there has been a substantial increase in the number and types of programming available to television viewers. In a typical American household, it is not uncommon for viewers to have available fifty or more television stations, and in some cases viewers have more than one hundred channels to choose from. Although the large number of programs are appreciated by those viewers who desire a wide variety of program selections at any given hour of the day, the high number of channels often makes it difficult for viewers to efficiently locate any single program. Furthermore, due to the ever increasing number of channels and programs at the fingertips of the television viewer, viewers often have difficulty in deciding what station or program to watch. For instance, although a viewer may locate an interesting program, the viewer may still spend a considerable amount of time navigating the remaining channels to confirm that there isn't a more desirable program selection.

Aiding television viewers with program selection has been addressed in a variety of manners. For instance, many cable systems offer a preview channel that offers subscribers a preview guide as to the programs being broadcast on each channel. Typically, preview guides indicate the programs currently showing on each channel, as well as programs to be aired within a certain period of time, such as during the next half hour or hour. Preview guides scroll program information past the screen so that the television subscriber can quickly ascertain what is being shown on each channel. However, this method of providing TV subscribers information regarding programming has some major drawbacks. First, consumers generally cannot view a program and the preview guide at the same time, because the preview guide is on a dedicated channel. Second, because the preview guide is not interactive or cannot be controlled by the subscriber, the subscriber must wait until the preview guide posts information regarding the programming for each of the channels. Because preview guides may post information regarding the channels sequentially according to channel number, a subscriber may be forced to watch the preview information for every channel until the viewer's desired channel is listed. Further drawbacks include the fact that preview channels offer limited information about programs, and typically only show program information for shows scheduled in the near future.

More recently, with the advent of digital broadcast systems, such as satellite systems and digital cable set-top systems, subscribers can be offered interactive menus that allow subscribers access to information regarding programming which is currently being aired and programming which is to be aired in the near future. Using these systems, subscribers can access a program guide that allows subscribers to interactively scroll through available programming, usually based on times and channels. Furthermore, subscribers can view details regarding programs scheduled to be aired at a specific time on a specific channel in the near future, such as the length of the program, a program summary, the program players or hosts, the program's rating, as well as other additional data. Many subscribers can also obtain information regarding the particular program they are viewing, at the time they are viewing the programming. For instance, a subscriber can watch a program and at the same time, retrieve information regarding that program. However, these systems face some major drawbacks. For example, using satellite systems, subscribers can only receive one channel at any given time. Furthermore, in digital systems, re-tuning to a new channel takes considerable amount of time, so that it may take a subscriber 30 seconds to scroll through 30 channels. Furthermore, subscribers using these systems cannot view multiple channels and program information simultaneously.

Therefore, what is needed is a system, method and apparatus that enables TV subscribers to simultaneously view video and audio associated with multiple television channels. Furthermore, it would be advantageous for a subscriber to be able to view a plurality of channels at the same time, with programming information regarding the respective channels simultaneously available to the subscriber.

### SUMMARY OF THE INVENTION

According to the present invention, a dedicated transmission channel transmits a data stream generated by a content provider, where the data stream includes data representing a plurality of video pictures associated with a plurality of television channels. Populating one data stream with data corresponding to multiple channels enables a Home Communication Terminal (HCT), in communication with a display device, to display multiple channels in a Composite Presentation to the subscriber. The Composite Presentation allows a subscriber to view a plurality of television channels on one channel, obviating the time consuming requirement that a subscriber re-tune to a separate television channel each time the subscriber wishes to view programming associated with a different television channel. This is exceptionally evident in comparison to digital broadcast systems such as digital satellite systems or digital cable set-top systems, where re-tuning to a separate channel requires time to buffer data for video decompression. Therefore, the present invention provides a method to access programming from multiple channels within a very short period of time.

### BRIEF DESCRIPTION OF THE DRAWINGS

FIG. 1 shows a block diagram of a Digital Broadband Delivery System (DBDS) including a Home Communication Terminal (HCT), according to one aspect of the invention.

FIG. 2 shows a block diagram illustrating the multiplexing of a plurality of video sources using a video multiplexer.

FIG. 3 shows a block diagram illustrating the sequencing of a plurality of video sources using a video sequencer.

FIG. 4A shows a block diagram illustrating a technique for producing a composite data stream comprising a plurality of video sources, according to one aspect of the present invention.

FIG. 4B shows a block diagram illustrating a technique for introducing video program guide data into the cable plant, according to one aspect of the present invention.

FIG. 5 shows a block diagram illustrating a technique for producing a composite data stream comprising a plurality of video sources, according to another aspect of the present invention.

FIG. 6 shows program data decoded from a frame-based digitally formatted data stream, and an illustrative example of a Composite Presentation produced from the program data, where the Composite Presentation is a video program guide, according to one aspect of the present invention.

FIG. 7 is a block diagram of several of the components comprising the HCT of FIG. 1, according to one aspect of the present invention.

FIG. 8 is a process flow diagram of the operation of a system of the present invention, according to one aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

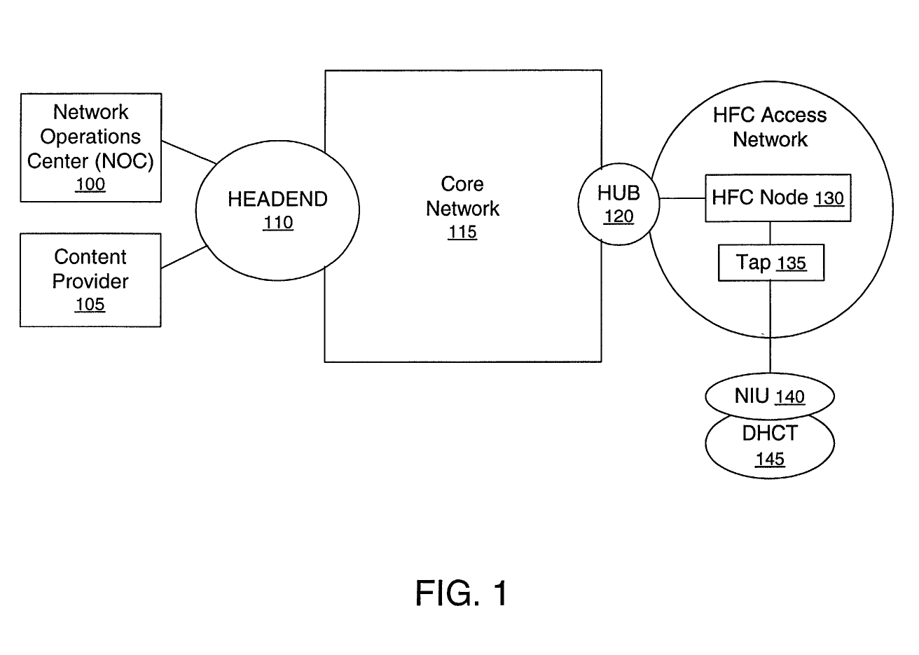

FIG. 1 shows a block diagram view of a Digital Broadband Delivery System (DBDS) 150, including a Home Communication Terminal (HCT) 145 of the present invention. Generally, the DBDS 150 is a high quality, reliable and integrated network system that features video, audio, voice and data services to Cable TV subscribers. A plurality of DBDSs can tie together a plurality of regional networks into an integrated global network so that Cable TV subscribers can receive content provided from anywhere in the world. The DBDS 150 shown in FIG. 1 can deliver broadcast video signals as digitally formatted signals in addition to delivering traditional broadcast analog video signals. Furthermore, the system can support one way broadcast services as well as both one-way data services and two-way media and data services. The two-way operation of the system 150 allows for subscriber interactivity with services, such as Pay-Per-View programming, View-on-Demand programs, and interactive applications, such as e-mail, World-Wide Web browsing, and interactive program guide applications.

The DBDS 150 provides the interfaces, network control, transport control, session control, and servers to access content and services, and distributes content and services to Cable TV subscribers. A typical DBDS 150 is composed of interfaces to one or more content providers 105, Network Operations Centers (NOC) 100, core networks 115 of headends 110, hubs 120, Hybrid Fiber/Coax (HFC) Access Networks 125, and subscribers' HCTs 145. Although FIG. 1 illustrates individual components in communication with the core network 115, it should be appreciated that the components illustrated in FIG. 1 may be representative of a plurality of such components. For example, although one hub 120 is illustrated in the figure, there may be a plurality of hubs 120 in communication with the core network 115. Furthermore, each of these hubs 120 can receive data from a plurality of content providers 105 in communication with one or more headends 110 of the core network 115. Similarly, each hub 120 may have a plurality of corresponding nodes 130, taps 135, and HCTs 145 in a tree configuration such that content can be distributed to a large number of subscribers. Thus, for each hub 120 there may be a plurality of nodes 130, for each node 130 there may be a plurality of taps 135, and for each tap 135 there may be a plurality of HCTs 145.

The content provider 105 can represent one or more providers of content, such as video channels, music channels, data channels, video services, audio services and data services. For example, according to one aspect of the invention, the content provider 105 could comprise a program guide data provider acting as a data service provider. According to another aspect of the invention, the content provider 105 could represent an Internet Service Provider (ISP) providing data to the system to enable subscribers web access or web-enhanced video via the subscriber's television set. The content provider 105 transmits content to a headend 110 for further transmission to subscribers downstream in the network 150. As illustrated in FIG. 1, a Network Operation Center (NOC) 100 is also in communication with the headend 110. The NOC 100, as will be appreciated by those of skill in the art, is an external management center interfaced with the DBDS 150 to allow for the remote operation of the system 150.

As stated above, content provided by a content provider 105 is communicated by the content provider 105 to one or more headends. From those headends the content is then communicated to the core network of hubs and onto a plurality of Hybrid/Fiber Coax (HFC) Access Networks 125. Typically, the HFC nodes 130 within the HFC Access Network 125 each service a local geographical area. The content provided from the content provider 105 is transmitted through the headend 110, hub 120 and HFC Access Networks 125 downstream to one or more taps 135 from each one of the HFC nodes 130 of the HFC Access Network 125. The hub 120 connects to the HFC node 130 through a fiber portion of the HFC Access Network 125. Usually, the HFC node 130 connects to a subscriber's HCT 145 through coaxial cable in a logical tree configuration, which is where the optical-to-electrical and electrical-to-optical conversations of the HFC access network 125 take place. From the HFC node 130 a coaxial drop connects the tap 135 to a Network Interface Unit (NIU) 140, which is a network demarcation point physically located on the side of a subscribers' home. The NIU 140 provides a transparent interface between the HFC node 130 and the subscribers' internal wiring. Coaxial cables are preferred in this part of the system because the electrical signals can be easily repeated with RF amplifiers. Typically, six amplifiers or less are located in series between the HFC node 130 and the subscribers' HCTs 145.

A typical DBDS, such as the DBDS 150 illustrated in FIG. 1, supports a plurality of channels being transmitted at any given time in a number of different formats such that HCTs 145 can receive a variety of content via the DBDS 150. The purpose of the HCT 145 is to tune to one or more of these channels and to present the content transmitted via these channels to the subscriber through a television, computer or like output device. These input channels can be provided by the one or more content providers 105, or by other entities in communication with the core network 115. Additionally, a few channels may be generated at a Headend 110 or at a Hub 120. A typical DBDS 150 can simultaneously support a number of transport channel types and modulation formats. Typically, a HFC Network is employed in the DBDS 150 to carry analog and digital signals over a large bandwidth, as will be appreciated by those of skill in the art. The analog and digital signals in HFC Network can be multiplexed using Frequency Division Multiplexing (FDM), which enables many different types of signals to be transmitted over the DBDS 150. Typically, a DBDS 150 using HFC supports downstream (i.e., in the direction from the Headend to the HCT) frequencies from 50 MHz to 870 MHz, whereas upstream frequencies (i.e., in the direction from the HCT to higher levels of the system) are in the 5 MHz to 42 MHz band.

Typically, downstream direction channels, having been multiplexed using frequency division multiplexing (FDM), and often referred to as in-band channels, include Analog Transmission Channels (ATCs) and Digital Transmission Channels (DTC) (also known as Digital Transport Channels). These channels carry video, audio and data services. For example, these channels can carry television signals, Internet data, or any additional types of data, such as Program Guide data. The ATCs are typically broadcast in 6 MHz channels having an analog broadcast composed of analog video and analog audio, and include Broadcast TV Systems Committee (BTSC) stereo and Secondary Audio Program (SAP) audio. Like the ATCs, the DTCs each occupy 6 MHz of the RF spectrum. However, the DTCs are digital channels usually comprising of 64- or 256-Quadrature Amplitude Modulated (QAM) digital signals formatted as Moving Picture Experts Group (MPEG) transport streams. As is well known in the art, an MPEG transport stream enables transmission of a plurality of DTC types over each 6 MHz RF (radio frequency) spacing, as compared to one ATC channel over the same frequency band. Types of digital transport channels include broadcast digital transmission channels, carousel digital transmission channels, and on-demand transmission channels. MPEG transport may be used to multiplex video, audio, and data in each of these DTCs. Data is formatted, such as in Internet Protocol (IP), mapped into MPEG packets, and inserted into the multiplexed MPEG (e.g., MPEG-2) transport stream.

Typically, each 6 MHz RF spacing assigned as a digital transmission channel can carry the video and audio streams of the programs of multiple television (TV) stations, as well as media and data that is not necessarily related to those TV programs or TV channels, as compared to one TV channel broadcast over one ATC that consumes the entire 6 MHz. The digital data is inserted into MPEG transport streams carried through each 6 MHz channel assigned for digital transmission, and then de-multiplexed at the subscribers' HCT so that multiple sets of data can be produced within each tuned 6 MHz frequency span. However, it will be appreciated that each digital transmission channel can also carry any information provided to the core network 115 by one or more content providers 105. Each transport stream can include video, audio and data representing multiple programs, which are in turn comprised of multiple elementary streams. The elementary streams include audio, video and data elementary streams, and are synchronized using a clock signal. Although the elementary streams are typically included in a single transport stream, it should be appreciated that the present invention can be effected using elementary streams distributed across multiple transport streams. PIDs, as are well known in the art, define each elementary stream that make up a component of a single program within the transport stream. As an illustrative example a program within a transport stream may be the HBO television channel, where each elementary stream comprising the program define the video, audio and data that makes up the HBO television channel.

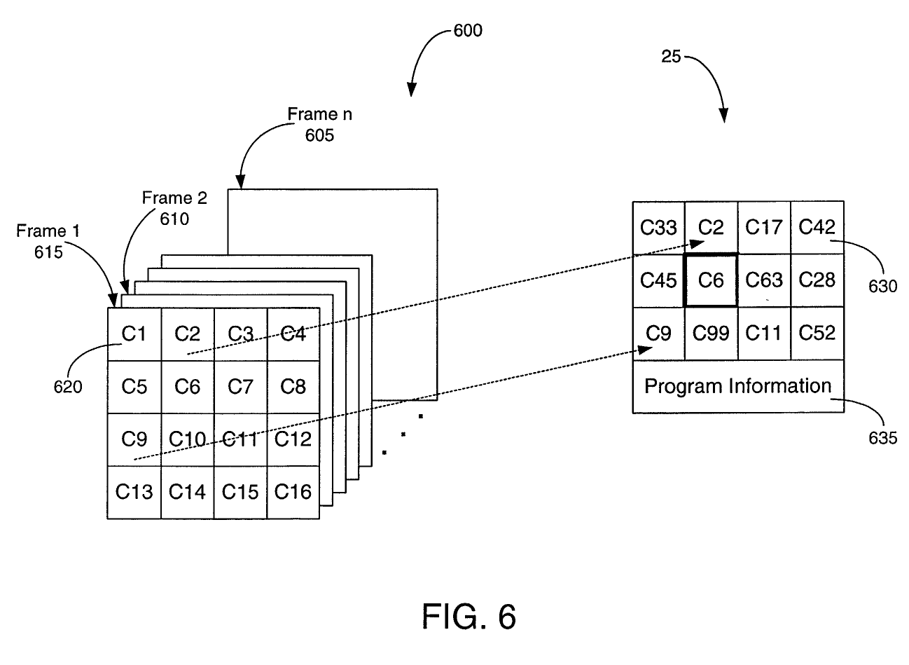

According to the present invention, a content provider generates and transmits a program over a dedicated broadcast digital transmission channel where the program includes data representing a plurality of video pictures associated with a plurality of television channels. The program can also include data associated with a plurality of television channels. Therefore, the program includes video, audio and data associated with a plurality of television channels, where the video, audio and data comprises elementary streams corresponding to each channel. It will be appreciated that the program includes its own elementary streams that comprise the combined elementary streams or at least a portion of the elementary streams from each television channel included within the program. As used herein, the program is also referred to as a data stream, and the audio, video and data within the data stream are contained within elementary streams within the program. Therefore the data stream is the program and is not intended to be confused with the data elementary element within the program. Populating one program, or data stream, with data corresponding to multiple channels enables an HCT 145 according to the present invention to display multiple channels in a Composite Presentation to a subscriber, as will be described in detail below with reference to FIG. 6. The Composite Presentation allows a subscriber to view a plurality of television channels on one channel, obviating the time consuming requirement that the subscriber re-tune to a separate television channel each time the subscriber wishes to view a video picture associated with a different television channel. This provides a significant advantage over digital broadcast systems, such as digital satellite systems or digital cable set-top systems, where re-tuning to a separate channel requires time to buffer data for video decompression. Therefore, the present invention provides a method to simultaneously access video, audio and related media from multiple channels with little or no delay. Using a conventional system, it may take a subscriber thirty (30) seconds to scan through thirty (30) channels. Using the present invention, the subscriber can tune to one channel to view a grid of video pictures associated with multiple channels. Furthermore, as will be described in detail below, the present invention also enables a subscriber to navigate through multiple video pictures without delay because the HCT 145 continuously decodes the data stream. Although the present invention will be described herein with reference to a digital data stream, it should be appreciated that content could also be provided over a dedicated analog channel to the HCT 145. However, an analog data stream may require both the content provider and HCT 145 to include synchronization hardware and software enabling video pictures and other content transmitted over the channel to be accurately received, stored and reconstructed at the HCT 145.

According to one aspect of the present invention, the data stream can include video associated with any number of separate television channels. The data stream can also include audio and/or text associated with each video picture. Because the quantity of data transmitted in one data stream is limited, however, it will be appreciated that the simultaneous presentation of a large number of video pictures and other media associated with a plurality of television channels may result in a degraded picture and/or a picture having a slow refresh rate. This negative consequence can be minimized where the refresh rate is increased. Furthermore, where a multiple-tuner HCT 145 is utilized, data representing video pictures, audio or other media can be received over more than one tuner within the HCT 145 so that larger amounts of data corresponding to each channel can be received. It will be appreciated that encryption can also be applied to the data stream for security so that the data, such as program guide data, may be received only by authorized HCTs 145. For instance, one individual subscriber may be authorized to receive program data via the data stream, while others may be authorized additional incremental amounts of program data (for example, program data for future days) according to a tiered service fee and/or depending on the amount of memory in the HCT 145.

According to one aspect of the invention, the data stream includes video encoded in a frame-based digital format, such as MPEG-1 or MPEG-2. As will be appreciated by those of skill in the art, MPEG can be encoded to display multiple independent and distinct frames (I-frames) per second. Utilizing a digital format such as MPEG, multiple independent frames may be transmitted in one data stream to the HCT 145. Additionally, each frame can include a grid of reduced size images from a plurality of channels. For instance, where the data stream includes 30 different frames, and each frame includes a 4 by 4 grid of images, it is possible to transmit snapshots of reduced size screen images of 480 (30 * 4 * 4) channels in one second. When and HCT 145 of the present invention is tuned to the dedicated data stream, the HCT 145 allows the subscriber to continuously view one or more of these 480 screen images, refreshed each second, without delay. Where fewer screen images are included in the data stream, the images may be refreshed at a higher rate. For example, in the above embodiment, 240 screen images may be provided and refreshed every one-half second.

Because the content provider has control over the content transmitted via the dedicated channel, the content provider may transmit data corresponding to one television channel, or one type of content, more frequently than other data. For instance, where one television station has paid the content provider a premium, the content provider may refresh data corresponding to that station at a high rate, such as at 30 video pictures per second. In this manner, the video picture associated with the television station will appear in full motion. However, it should be appreciated that where the data stream includes a higher amount of data for one channel, other channels in that data stream will suffer to some degree, as the amount of content transmitted over the data stream is limited.

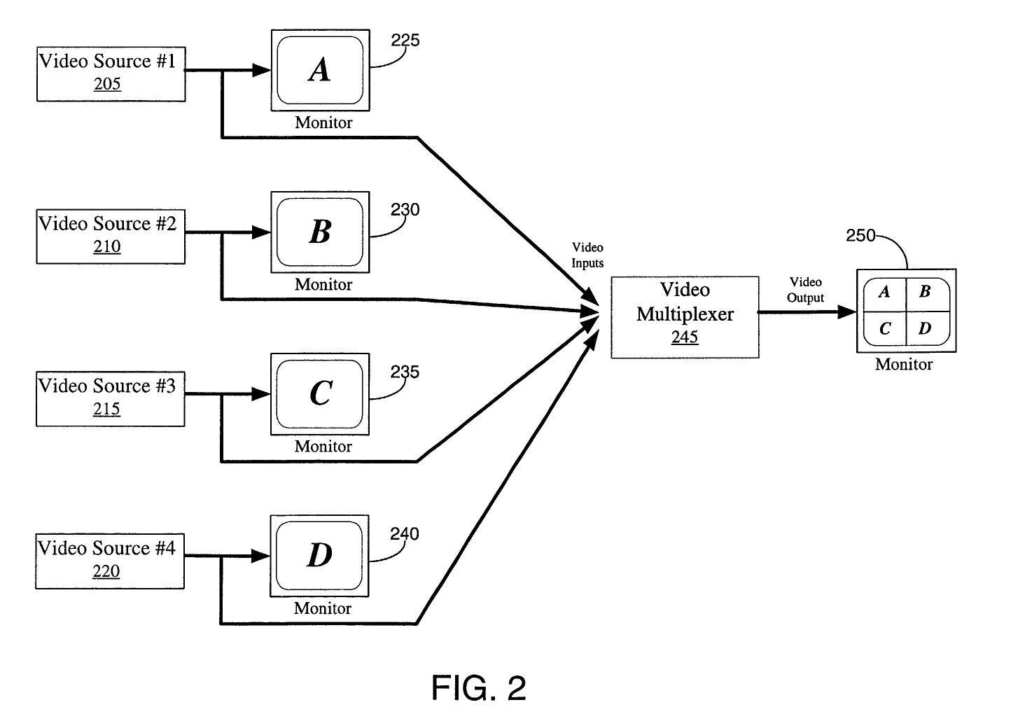

Although the content is discussed herein in reference to video pictures, such as video associated with television channels, it should be appreciated that the content can also include audio, text, or other media the content provider desires to broadcast. As an illustrative example, the content provider may wish to incorporate some advertising feature into the text of program information the viewer accesses. The media can also include interactive media that allows a subscriber to order specialized programming, such as pay-per-view presentations. FIGS. 2-5 illustrate two methods for creating the data stream, according to two embodiments of the present invention. The first method generates the data stream using a combination of conventional video equipment, whereas the second and preferred method embraces a more integrated and efficient approach to generating the stream. Although the stream will be described as a video program guide stream, it should be appreciated that the stream may represent any composite data stream including audio, visual, textual, and like media, and that the embodiments represented herein are merely illustrative, and are not meant to be limiting.

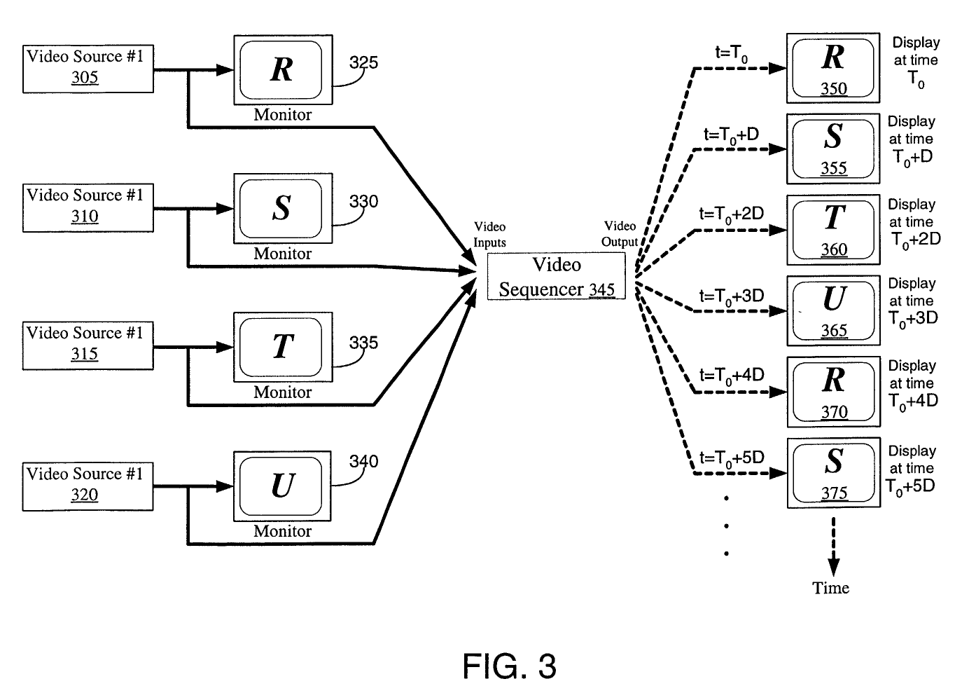

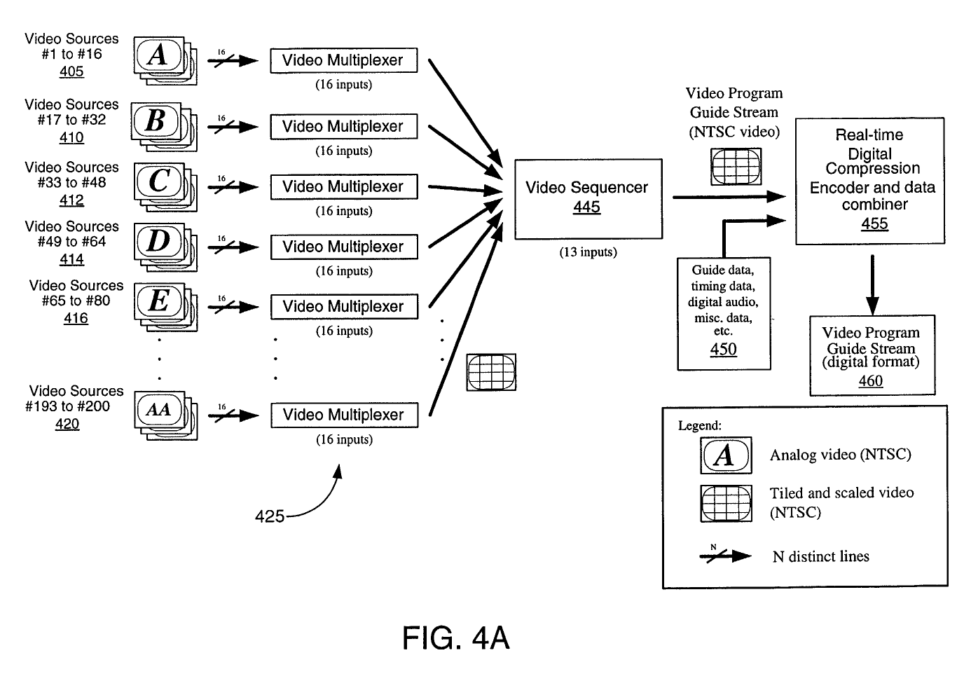

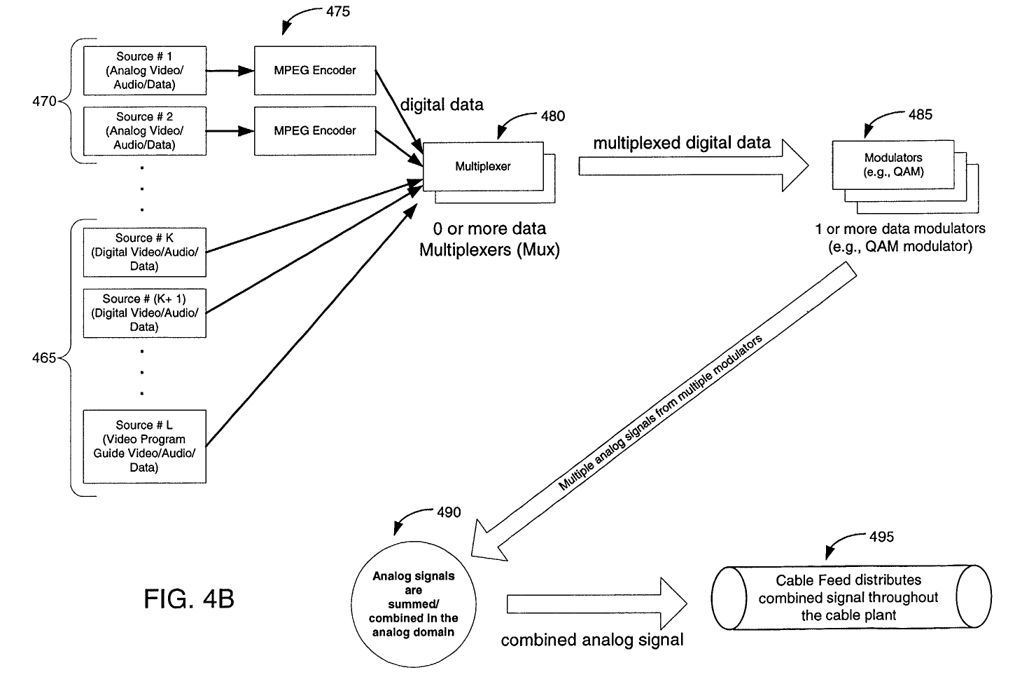

A first method for creating a composite data stream is described with respect to FIGS. 2, 3 and 4. More particularly, FIGS. 2 and 3 illustrate the functions of video multiplexers and video sequencers, respectively, which are used in the first method to produce a composite data stream according to the method illustrated in FIG. 4A. As illustrated in FIG. 2, multiple video sources 205, 210, 215, 220 in an analog video format (such as NTSC or PAL format) are typically viewed independently on monitors 225, 230, 235, 240. To create a multiplexed output the sources 205, 210, 215, 220 are combined are in a video multiplexer 245, which is an off-the-shelf video component used in the video/surveillance industry to combine several analog video sources into one new video output. Thus, by multiplexing the video pictures using the multiplexer 245 several distinct video sources may be monitored on one display or monitor 250, in real-time. It should be noted, however, that multiplexing the video sources to create a data stream that contains a combined video of each of the multiplexed video pictures results in some image degradation due to the video scaling of the several video sources 205, 210, 215, 220. The resulting video output contains the combined images of all the video sources 205, 210, 215, 220 entering the video multiplexer 245.

FIG. 3 shows the reception of multiple video sources 305, 310, 315, 320 at a video sequencer 345, which is another off-the-shelf video component for sequencing video sources or video pictures. As in the embodiment shown in FIG. 2, the multiple video sources are in an analog video format and may be viewed independently on monitors 325, 330, 335, 340. The video sequencer 345 has several video inputs and one video output. The video output is constructed by selecting each video source 305, 310, 315, 320 sequentially in round-robin fashion. The video output is illustrated on a display, broken up in FIG. 3 into multiple displays 350, 355, 360, 365, 370, 375 representative of the display at different times. Visually, the video output shows a first video source 305 for a period of time 350, a second video source 310 for a period of time 355, and so on, until all video sources are displayed 350, 355, 360, 365, 370, 375. The process continues indefinitely in a round-robin fashion. The function of the video sequencer 345 is to present a single stream output that contains the real-time video contents of its video input sources one source at a time. Unlike the video multiplexer 245, the video sequencer 345 does not result in image degradation of the video sources 305, 310, 315, 320 because scaling is not involved.

By using one or more video multiplexers and one or more video sequencers, a video stream containing video images from a large number of video sources can be generated, as is illustrated in FIG. 4A. More specifically, FIG. 4A shows an embodiment of a system generating a video program guide data stream that contains video content of 200 NTSC channels transmitted via 200 respective video sources 405, 410, 412, 414, 416, 420. The video sources 405-420 are multiplexed at a plurality of video multiplexers 425. For instance, in FIG. 4A each video multiplexer includes 16 inputs and 1 output, where the 16 inputs each correspond to an analog video source transmitted to the video multiplexer over a distinct line, and the single output is tiled and scaled video (or a grid) including images from each analog video source received at the multiplexer inputs. The plurality of multiplexed signals, one for each of the plurality of video multiplexers 425, are received at a video sequencer 445. The video sequencer 445 enables the display of one of the multiplexed video outputs corresponding to 16 video sources at any given time. Like each of the video multiplexers 425, the video sequencer 445 includes a plurality of inputs (at least one for each multiplexer output) and one output. Collectively, the video sequencer 445 output is an NTSC video program guide stream, which is digitized by a real-time digital compression encoder and data combiner 455. After digitization, the digital compression encoder and data combiner 455 may also combine the digital stream with timing information, channel information, digital audio, layout information, and channel and set-top related information to generate a digital video program guide stream accessible by the subscriber, as will be described in greater detail with respect to FIGS. 6-8.

Next, FIG. 4B shows a block diagram illustrating a technique for introducing video program guide data into the cable plant, according to one aspect of the present invention. The cable plant is the physical infrastructure for delivering and retrieving media data to and from the users. At a high level, the video program guide data can be one or more video/audio/data sources being incorporated into the broadcast media of the cable plant. Here, the video, audio, and data sources are essentially a program as defined by the MPEG system standard. After the video program guide data is generated, it is fed back into the cable plant as another source of video/audio/data. The Video Program Guide program, comprises digital video/audio/data 465 or analog video/audio/data 470 is received at zero or more data multiplexers 480 where there is a need to groom, normalize, multiplex, or rate control the data. The analog sources 470 may pass through MPEG decoders 475 prior to being input at the one or more multiplexers 480. With or without passing through the multiplexers 480, the video program guide program can then be inserted into one or more QAM modulators 485. The resulting analog modulated data from the modulators are then combined (summed) 490 in the analog domain to arrive at a combined analog feed suitable for distribution 495 in the cable plant.

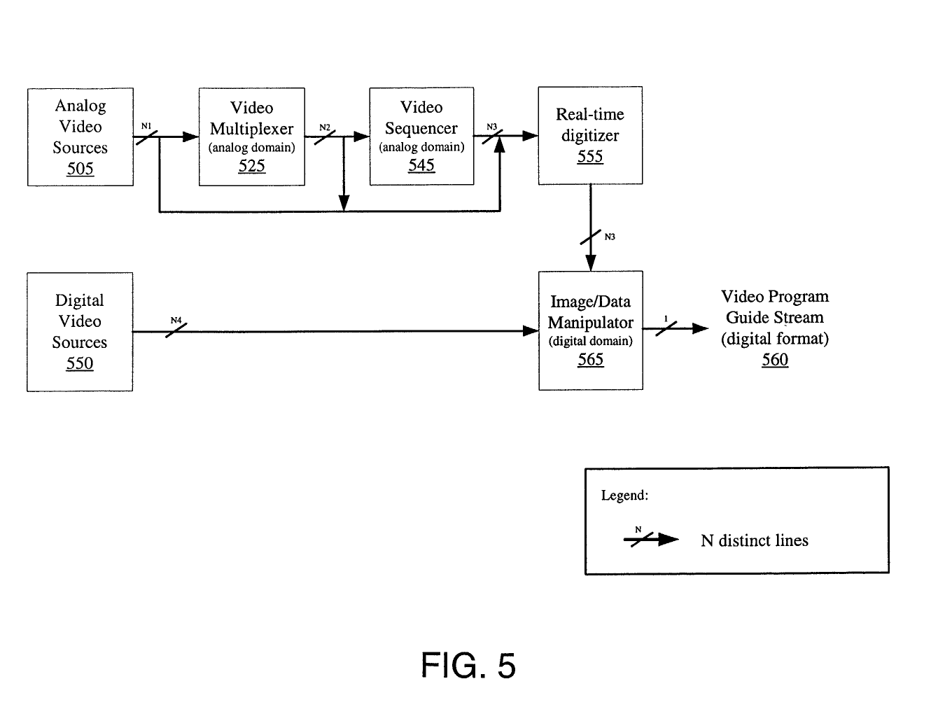

FIG. 5 illustrates a second and preferred method of creating a composite data stream. According to this embodiment, each of the video sources to be combined into one data stream can be in either the analog domain (e.g., NTSC or PAL) 505 or the digital domain (i.e., MPEG-2, MPEG-4, etc.) 550. As in the previous method, the analog video sources 505 may be processed sequentially through the analog video manipulation process provided by a video multiplexer 525 and video sequencer 545. Alternatively, the analog video sources 505 may skip the analog manipulation process and go directly through a digitization process provided by a real-time digitizer 555. The resulting digitized video data from the converted analog video sources and the already digitized digital sources can then be combined and manipulated in the image/data manipulator 565, which may be at the headend or within a set-top box, personal computer or similar device. The image/data manipulator generates a data stream, such as a video program guide stream 560 in the present example, by digitally scaling video frames, capturing a snapshot of a video frame, compressing or decompressing the video data, decrypting or encrypting video frame data, cropping and moving video frame data from one image to another, noise filtering video frame data, reducing the bit-rate to effect image degradation to make data more compressible, enhancing the bit rate to re-introduce details or sharpness, and/or embed or combine additional data into the stream, such as program guide information, audio data, frame related data, closed caption, miscellaneous data, and the like.

It will be appreciated by those of skill in the art that if the entity that digitizes the composite stream, the real-time digital compression encoder 455 and real-time digitizer 555 in the above examples, and the entity that decodes the video program guide stream (i.e., set-top box, personal computer, network computer, etc.) can both handle faster than normal frame transmission, it is possible to put more frames per second into the data stream. Where the data stream is a video program stream this would either increase the perceived quality of the video because the channel refresh rate would increase or more content would be accommodated where the refresh rate remains the same. This will be more fully understood with reference to FIG. 6.

FIG. 6 shows program data 600 decoded from a frame-based digitally formatted data stream, where the program data 600 includes plurality of video pictures 620 presented within multiple frames 615, 610, 605. FIG. 6 also shows an illustrative example of a Composite Presentation produced from the program data, where the Composite Presentation is a video program guide 625, according to one aspect of the present invention. As discussed above, the program data 600 includes a plurality of frames, frame 1 615 to frame N 605, each of which include multiple video pictures 620. As illustrated, each video picture is associated with a particular channel, such as a television channel. For instance, the video picture located in the upper leftmost portion of frame 1 615 corresponds to television channel 1 (C1), and the video picture in the lower rightmost portion of frame 1 615 corresponds to television channel 16 (C16). Therefore, the program data can include video pictures corresponding to N*X*Y channels, where N is the number of frames, X is the number of columns (of video pictures) per frame, and Y is the number of rows (of video pictures) per frame. Preferably, the program data 600 will be generated in a predetermined order, as shown in FIG. 6, such that the channels will be received in order. However, this is not necessary, as each video picture in the data stream includes identification information specifying the channel or content of the video picture. This can be accomplished based upon a header associated with packets carrying data associated with a particular channel or with specific content. An example of one such header is an MPEG user data field. MPEG user data fields are well known in the art. Each video frame has a picture header and zero or more user data fields, which carry frame-related information. Alternatively, a time stamp can be associated with particular data and/or content, where the time stamp aids in the reorganization of program data after its transmission over the DBDS.

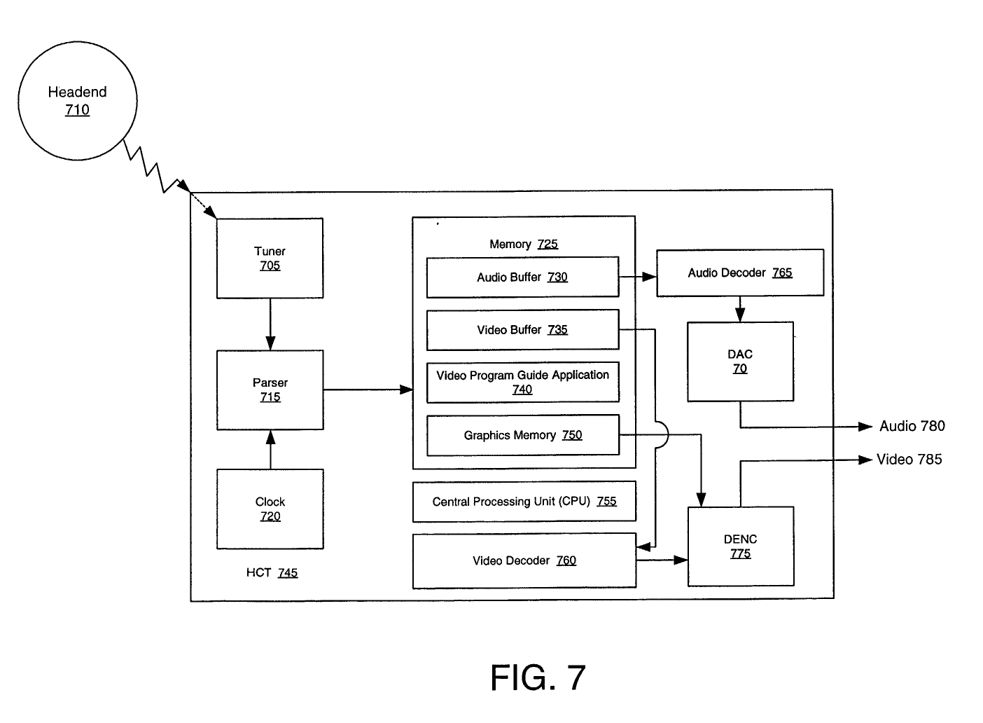

FIG. 6 further shows an illustrative Composite Presentation, where the Composite Presentation is a video program guide 625 generated using the program data 600, according to one illustrative example of the present invention. An HCT according to the present invention extracts video pictures from the various frames 615, 610, 605 of the data stream and combines one or more of the video pictures to produce the Composite Presentation. As will be explained in detail below with reference to FIG. 7, the HCT stores the video images associated with each channel digitally in the HCT such that the channels can be arranged in any user specified order, such as the order shown in FIG. 6. Because the program data 600 is stored within the HCT, a subscriber can configure the programmable HCT to generate one or more customized video program guides. In programming the HCT, the subscriber is only limited by the quantity of data received by the HCT. Therefore, the subscriber can program the HCT to incorporate into one Composite Presentation data corresponding to a diverse set of television channels, so long as data corresponding to the television channels is included in the data stream. In addition to selecting content to view, the subscriber may also choose the form with which to view the content. For instance, as illustrated in FIG. 6, the subscriber may simultaneously view 12 video pictures (in a 4×3 format), where each video picture is associated with a television channel. Alternatively, the subscriber may choose to view only 2 or 3 pictures simultaneously. It should be appreciated that these video pictures can be collected from any frame (1−N) of the program data 600. For instance, in FIG. 6 a video picture corresponding to channel 112 (C112) is illustrated in the same Composite Presentation as a video picture representing channel 2 (C2), although each of these originate from different frames.

According to one advantageous aspect of the present invention, in addition to generating a video program guide based upon video pictures, the subscriber can also view program information 635 associated with one or more of the video pictures. Using a selection mechanism, which can include subscriber-manipulated graphics enabling the subscriber to choose among a plurality of displayed video pictures, the subscriber can select a particular video picture. The selection mechanism may be represented graphically as a line, box, shading or other suitable means, so that the user can navigate among the multiple presented video pictures using an input device such as a remote control. Such graphics are well known to those of skill in the art. After the subscriber selects a specific video picture, audio corresponding to the video picture can be played (if included within the data transmitted to the HCT) and the subscriber is presented with program information 635 in the form of text displayed on virtually any portion of the Composite Presentation. The text may be presented separate from the video pictures, as in FIG. 6, or may be presented superimposed upon one or more video pictures.

It will be appreciated that the subscriber can program multiple video program guides 625 based upon the program data 600, each containing multiple video pictures associated with a plurality of television channels. The generation of the Composite Presentation will result in very minimal delay because the HCT is not required to tune to a different channel to generate the Composite Presentation. Therefore, the subscriber can program a plurality of video program guides 625 and display each consecutively with little delay. For instance, a subscriber could generate customized, named pages, such as a “sports” page, “news” page, “movie” page, and the like so that similar programming from multiple channels can be simultaneously viewed. As stated above, the subscriber can program these video program guides such that each has different channels or form (i.e., presentation). According to one aspect of the invention, a subscriber can generate an all text program guide. According to another aspect of the invention, a subscriber could view textual descriptions of one or more channels while simultaneously viewing only one channel. Additionally, according to one aspect of the invention, the subscriber can include a video picture in the same location in multiple video program guides, such that the channel appears unchanged when the subscriber changes program guides. For instance, where television channel 6 is the subscriber's favorite television station, the subscriber may incorporate video pictures corresponding to channel 6 in the upper leftmost corner of each video program guide, such that when the subscriber changes guides the channel will remain in the same composite presentation location. According to yet another aspect of the invention, the subscriber program guide can allow the subscriber to continuously scroll through all video pictures available in the data stream. By using a First-In-First-Out (FIFO) method, an HCT of the present invention allows a subscriber to continuously displace video presentations in the video program guide.

Where the subscriber requests a new channel via a selection on a remote control or like input device, the HCT may be configured to automatically remove the first viewed channel from the video program guide. For instance, where a video program guide presents four channel, Channel 1 through Channel 4, respectively, when the subscriber chooses to view the next channel, the video program guide will be changed to present Channel 2 through Channel 5. Additionally, according to another aspect of the invention, the subscriber is able substitute some of the displayed channels with alternative channels, in a similar method to the movement or sliding of frames in and out of a displayed window of cells in a computer spreadsheet. In this regard, a subscriber can continuously replace pictures with previously non-displayed pictures. This function can best be expressed with the illustrative analogy where the video pictures corresponding to each channel are mapped on the surface of a sphere. Because the spatial relationships of video pictures or channels are continuous in every direction, a subscriber capture and views previously non-displayed video pictures by shifting the composite video program guide display around the sphere such that previous video pictures are lost while new pictures are within the program guide.

According to another interpretation, it can be imagined that all rows (Y) and columns (X) have their own FIFO, and the beginning and end of each row and column are connected. This allows multiple television channels to be dropped simultaneously from the video program guide in favor of multiple new television channels.

As will be appreciated by one of ordinary skill in the art, the HCT of the present invention may be embodied as a method, a data processing system, or a computer program product. Accordingly, the HCT may take the form of an entirely hardware embodiment, an entirely software embodiment or an embodiment combining software and hardware aspects. Furthermore, the HCT may take the form of a computer program product on a computer-readable storage medium having computer-readable program code means embodied in the storage medium. Any suitable computer readable storage medium may be utilized including hard disks, CD-ROMs, optical storage devices, or magnetic storage devices.

The present invention is described below with reference to block diagrams and flowchart illustrations of methods, apparatus (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

FIG. 7 is a block diagram of the components included within a HCT 745 of the present invention, according to one aspect of the invention. The HCT 745 includes a tuner 705, parser 715, clock 720, memory 725, Central Processing Unit (CPU) 755, video decoder 760, audio decoder 765, digital to analog converter 770, and a digital encoder 775. The CPU 755, in combination with the Video Program Guide Application 740, which is an executable software program stored within memory 725, control the function of the HCT 745. More specifically, the Video Program Guide Application 740 receives commands from the subscriber via one or more input devices, and in conjunction with the CPU 755, manipulates the hardware to generate the subscriber defined Composite Presentation from the received program data.

FIG. 7 shows a headend 710, included in a DBDS or like network, through which content is transmitted to the HCT 745. According to one aspect of the present invention, a content provider located at the headend 710 or upstream from the headend 710 generates and broadcasts a data stream that contains content associated with one or more channels, as described in detail above, over a dedicated channel to the HCT 745. The tuner 705 receives the data stream provided by the content provider and transmitted to the HCT 745 through the headend 710. According to one aspect of the invention, the tuner 705 is a QUAM tuner preferably capable of receiving signals from an HFC Plant (e.g., an 870 MHz HFC Plant), and capable of analog and digital (64/256 QAM) tuning to a single RF channel from a multiplicity of spaced RF channels. It should be appreciated that although the HCT 745 is illustrated in FIG. 7 as including only one tuner 705, the HCT 745 can include multiple tuners for simultaneously receiving multiple data streams from a plurality of channels. Multiple tuners are known in the art of set-top boxes, and may be preferred over a single tuner because additional content can be received by the HCT 745. Because each tuner can select only one inbound channel at a time, a plurality of tuners can be provided so that multiple channels can be received simultaneously using the HCT 745. For instance, multiple tuners would allow the HCT 745 to receive additional frames or video images in comparison to a single tuner. Furthermore, although a single tuner can adequately receive on one channel video pictures and audio or text associated with the video pictures, additional tuners could receive audio or text on a independent channel from the video pictures such that quality of this additional content is not degraded.

The parser 715 receives the data stream, such as an MPEG-2 Transport Stream, and filters the stream based upon headers, such as Program IDs (PIDs), MPEG user data fields, or the like, located within the data stream. During transmission over the DBDS, individual data packets are typically jumbled and out of order. As a result, and because the data stream is continuous, markers identify data corresponding to, for instance, each frame, channel or like packet of content included in the program data. For example, the tuner may receive video picture data corresponding to television channel 1, followed by video picture data corresponding to television channel 2, followed by audio data associated with television channel 3, followed by additional video picture data corresponding to channel 1. The headers associated with each packet enable the HCT 745 to organize the data such that the transmitted data can be reconstructed. The parser 715 is in electrical communication with a clock 720, which synchronizes the parser's collection of data and forwarding of data to memory 725.

The parser 715 forwards collected program data to memory 725, specifically, a video buffer 735 and audio buffer 730. Although not illustrated in FIG. 7, the HCT 745 could also include additional memory stacks, such as video and audio buffers, and text or content buffers. The audio and video buffers 730, 735 are preferably FIFO storage devices, such as registers, which retain the parsed data temporarily. Also resident within the memory 725, the Video Program Guide Application 740 is an executable file enabling a subscriber to define a desired Composite Presentation, as described above with respect to FIG. 2. Based upon subscriber inputs, the Video Program Guide Application 740 identifies the program data necessary to produce the subscriber requested real-time video program guide, and locates the program data in the temporary buffer storage 730, 735. The Video Program Guide Application 740 then forwards instructions to the video decoder 760 and audio decoder 765 to retrieve the specific data for inclusion into the Composite Presentation.

In communication with the Video Program Guide Application 740, the video decoder 760 retrieves the parsed data stored within the video buffer 735 and decodes or decompresses the data to produce a frame, such as the frames 615, 610, 605 illustrated in FIG. 6. However, where the subscriber may not wish to view an entire frame, but rather video associated with one channel within the frame, the correct image must be parsed from, or pulled out of, the frame. To accomplish this, the graphics engine and memory 750 receives the decompressed frame image, and based upon instructions from the Video Program Guide Application 740 and CPU 755, parses the frame to retrieve the desired image segment. Because the subscriber will likely request a view of multiple images corresponding to multiple television channels, the graphics engine and memory 750 may be required to parse multiple images from one or more frames, and store the images temporarily in memory 725 until it completes the composite presentation. Alternatively, the Composite Presentation can be updated immediately after each image is parsed such that each newly parsed video image is immediately displayed to the subscriber. After the graphics engine and memory 750 completes the Composite Presentation, it forwards the image representing the Composite Presentation to the Digital Encoder (DENC) 775, which converts the image into NTFC (or other suitable format) for transmission 785 to the display device. It should be appreciated that the process of determining the appropriate program data retrieved from the video buffer, and its conversion and incorporation into the composite presentation occurs repeatedly (many times each second), such that any subscriber instruction or change in video will be quickly updated into the composite presentation.

The Audio Decoder 765 receives the audio data directly from the audio buffer and forwards the audio to the DAC 770 for conversion and transmission 780 to the display device. Unlike the video, which required manipulation by the graphics engine and memory 750, the audio data includes headers identifying the corresponding video picture. As a result, further conversion is not required. However, the Video Program Guide Application 740 synchronizes the presentation of the audio and the subscriber selected video so that the video and audio match. It will also be appreciated that text based data or other media content must also be decoded and forwarded to the display device in synchronization with the audio and video. For instance, text based data must be decoded and incorporated into the Composite Presentation image where the viewer commands the HCT 745. Therefore, although the Video Program Guide Application 740 or CPU 755 can execute these tasks, one or more additional decoders and clocks may be included within the HCT for these purposes.

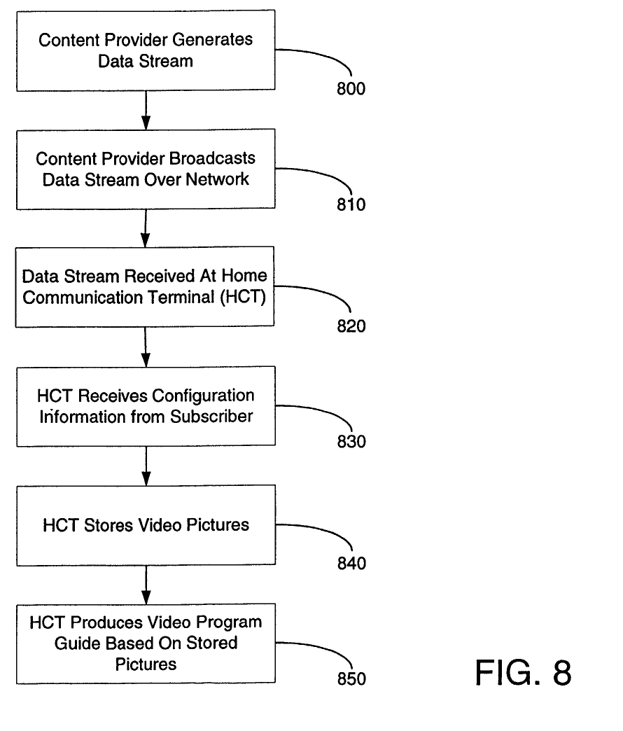

FIG. 8 is a process flow diagram of the operation of a system of the present invention, according to one aspect of the present invention. As illustrated in FIG. 8, a content provider generates a data stream 800 which includes a plurality of video pictures associated with a plurality of television channels. The content provider broadcasts 810 the data stream over a network having a plurality of channels, on a dedicated channel of the plurality of channels of the network. The data stream is thereafter received 820 at a home communication terminal (HCT). The HCT receives 830 configuration information from a subscriber of the HCT, where the configuration information identifies the video pictures to be stored. The configuration information also enables the real-time video guide to be customized by the subscriber. According to one aspect of the invention, the Video Program Guide Application presents one or more graphical user interfaces to the subscriber via the display, facilitating the customization of the Composite Presentation by the subscriber. Next, the HCT stores 840 at least two video pictures of the plurality of video pictures. Finally, the HCT produces a real-time video program guide 850 based upon the stored video pictures, such that the real-time video program guide may be accessed by the subscriber with minimal delay.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing a real-time video program guide, comprising:
generating an elementary stream, the elementary stream including a plurality of video frames representing a plurality of videos associated with a plurality of programs;
broadcasting the elementary stream over a network;
receiving the elementary stream at a home communication terminal (HCT); and
producing a real-time video program guide based upon the plurality of videos, such that the real-time video program guide may be accessed by a subscriber.

2. The method of claim 1, further comprising storing at the HCT at least two video frames of the plurality of video.

3. The method of claim 1, further comprising:
generating at least one audio stream associated with the elementary stream, wherein the at least one audio stream includes audio associated with the plurality of programs;
broadcasting the at least one audio stream over the network; and
producing a real time video program guide based upon the audio associated with the plurality of programs.

4. The method of claim 1, further comprising:
generating an data elementary stream associated with the elementary stream, wherein the data elementary stream includes data associated with the plurality of programs;
broadcasting the data elementary stream over the network; and
producing a real time video program guide based upon the data associated with the plurality of programs.

5. The method of claim 1, wherein producing the real-time video program guide comprises producing a real-time video program guide comprising a composite display including at least two video frames.

6. The method of claim 1, further comprising:
receiving configuration information from the subscriber prior to displaying the at least two video frames of the plurality of videos; and
wherein the configuration information identifies video frames from the plurality of videos.

7. The method of claim 1, further comprising:
receiving configuration information from the subscriber prior to producing the real-time video guide; and
wherein producing the real-time video program guide comprises customizing the real-time video guide based at least in part on the configuration information.

8. A method for generating a video program guide, comprising:
receiving at a home communication terminal (HCT) an elementary stream broadcasted on a channel of a network broadcasting a plurality of channels, the elementary stream comprising a plurality of video frames;
producing a video program guide, the video program guide comprising a composite presentation of at least two video frames of the elementary stream; and
displaying the video program guide.

9. The method of claim 8, further comprising storing multiple portions of the elementary stream.

10. The method of claim 9, further comprising:
receiving configuration information from an operator of the HCT prior to storing the multiple portions of the data stream; and
wherein the configuration information identifies portions of the data stream to be stored.

11. The method of claim 8, further comprising:
receiving configuration information from an operator of the HCT prior to producing the video program guide; and
wherein producing the video program guide comprises customizing the video program guide based at least in part on the configuration information.

12. The method of claim 8, further comprising
receiving at a home communication terminal (HCT) an audio stream associated with at least one video frame of the plurality of video frames; and
producing a video program guide, the video program guide comprising at least a portion of the audio stream.

13. A system for generating a real-time video program guide through access of video content, comprising:
a network that transmits content to a plurality of Home Communication Terminals (HCTs) over a plurality of channels;
a content provider that broadcasts an elementary stream over a dedicated channel of the plurality of channels, the elementary stream comprising program data corresponding to a plurality of video frames; and
an HCT of the plurality of HCTs, in communication with the content provider via the network,
wherein the HCT receives the elementary stream broadcast by the content provider, wherein the HCT generates a video program guide display based upon at least some of the plurality of video frames, and wherein the plurality of video frames are associated with content received by the HCT over at least two channels of the plurality of channels.

14. The system of claim 13, wherein a elementary stream comprises video frames corresponding to a plurality of television channels.

15. The system of claim 13, wherein the video program guide display comprises a multimedia display; and
wherein the multimedia display includes audio and video based upon content received by the HCT over the at least two channels of the plurality of channels.

16. The system of claim 13, wherein the HCT is programmable by a subscriber.

17. The system of claim 13, wherein the HCT includes a plurality of tuners for simultaneously receiving content transmitted over a plurality of channels of the network.

18. A home communication terminal (HCT) enabling the generation of a real-time video program guide, viewable on a display, through access of video content, comprising:
at least one tuner that receives over one channel a data stream broadcast by a content provider, the data stream comprising data corresponding to a plurality of videos associated with a plurality of television channels;
a video program guide application enabling a subscriber to select multiple video frames of the plurality of videos to create a composite presentation; and
an output port for transmitting the composite presentation to the display, such that the multiple video frames are simultaneously viewable on the display.

19. The HCT of claim 18, wherein the video program guide application further enables the subscriber to navigate through multiple composite presentations of video frames;
and wherein each video frame corresponds to a television channel.

20. The HCT of claim 18, further comprising a graphics memory for parsing one or more video frames from the plurality of videos to generate the composite presentation.

21. The HCT of claim 18, wherein the video program guide application further processes the data to enable the subscriber to view text associated with one or more of the multiple video frames included in the composite presentation.

22. The HCT of claim 18, wherein the video program guide application further processes the data to enable the subscriber to be presented audio signals associated with one or more of the multiple video frames included in the composite presentation.

23. A method of providing a data stream for use in generating a real-time video program guide, comprising:
receiving content associated with a plurality of television channels;
generating a data stream, the data stream including a plurality of video pictures associated with at least some of the plurality of television channels;
broadcasting the data stream over a network, on a dedicated channel of a plurality of channels of the network.

24. The method of claim 23, wherein the data stream further comprises audio associated with at least one of the plurality of video pictures included in the data stream.

25. The method of claim 24, wherein generating the data stream further comprises generating a data stream where the data stream includes text associated with at least one of the plurality of video pictures included in the data stream.

26. The method of claim 23, wherein generating the data stream comprises processing analog video sources and digital video sources to generate the data stream.

27. The method of claim 23, wherein generating the data stream comprises scaling at least one of the plurality of video pictures.

28. The method of claim 23, wherein the data generating the data stream comprises multiplexing the plurality of video pictures.

29. The method of claim 23, wherein generating the data stream comprises sequencing the plurality of video pictures.

30. A method of providing a real-time video program guide, comprising:
generating at least one elementary stream, the at least one elementary stream including audio representing audio associated with a plurality of programs;
broadcasting the at least one elementary stream over a network;
receiving the at least one elementary stream at a home communication terminal (HCT); and
producing a real-time video program guide based upon the audio, such that the real-time video program guide may be accessed by a subscriber.

31. The method of claim 30, further comprising:
generating an data elementary stream associated with the at least one elementary stream, wherein the data elementary stream includes data associated with the plurality of programs;
broadcasting the data elementary stream over the network; and producing a real time video program guide based upon the data associated with the plurality of programs.

32. A method of providing a real-time video program guide, comprising:
generating at least one elementary stream, the at least one elementary stream including data representing audio associated with a plurality of programs;
broadcasting the at least one elementary stream over a network;
receiving the at least one elementary stream at a home communication terminal (HCT); and
producing a real-time video program guide based upon the data, such that the real-time video program guide may be accessed by a subscriber.
